(19) United States
(12) Patent Application Publication
(10) Pub. No.: US 2016/0192377 A1
(43) Pub. Date: Jun. 30, 2016

(54) ADAPTIVE EDCA ADJUSTMENT FOR DYNAMIC SENSITIVITY CONTROL

(71) Applicant: QUALCOMM Incorporated, San Diego, CA (US)

(72) Inventors: Yan ZHOU, San Diego, CA (US); Gwendolyn Denise BARRIAC, Encinitas, CA (US); Simone MERLIN, San Diego, CA (US); George CHERIAN, San Diego, CA (US)

(21) Appl. No.: 14/981,713

(22) Filed: Dec. 28, 2015

Related U.S. Application Data
(60) Provisional application No. 62/098,253, filed on Dec. 30, 2014.

(51) Int. Cl. H04W 72/08; H04W 24/08

(52) U.S. Cl. CPC H04W 72/085; H04W 24/08

(57) ABSTRACT

A method, an apparatus, and a computer-readable medium for wireless communication are provided. In one aspect, an apparatus is configured to adjust an EDCA parameter based on a signal strength of a signal from an access point or a distance between the station and the access point and to communicate with the access point based on the adjusted EDCA parameter.

### CROSS-REFERENCE TO RELATED APPLICATION(S)

This application claims the benefit of U.S. Provisional Application Ser. No. 62/098,253, entitled “ADAPTIVE EDCA ADJUSTMENT FOR DYNAMIC SENSTIVITY CONTROL” and filed on Dec. 30, 2014, which is expressly incorporated by reference herein in its entirety.

### BACKGROUND

1. Field

The present disclosure relates generally to communication systems, and more particularly, to adaptive enhanced distributed channel access (EDCA) for dynamic sensitivity control (DSC).

2. Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The systems, methods, computer-readable medium, and devices of the invention each have several aspects, no single one of which is solely responsible for the invention's desirable attributes. Without limiting the scope of this invention as expressed by the claims which follow, some features will now be discussed briefly. After considering this discussion, and particularly after reading the section entitled “Detailed Description,” one will understand how the features of this invention provide advantages for devices in a wireless network.

One aspect of this disclosure provides an apparatus (e.g., a station) for wireless communication. The apparatus is configured to adjust an EDCA parameter based on a signal strength of a signal from an access point or a distance between the station and the access point and to communicate with the access point based on the adjusted EDCA parameter.

In another aspect, an apparatus for wireless communication is provided. The apparatus includes means for adjusting an EDCA parameter based on a signal strength of a signal from an access point or a distance between the apparatus and the access point. The apparatus may include means for communicating with the access point based on the adjusted EDCA parameter. In an aspect, the EDCA parameter may include one of a contention window minimum (CWMIN) parameter, a contention window maximum (CWMAX) parameter, an arbitration inter-frame space number (AIFSN) parameter, or a transmit opportunity (TXOP) parameter. In another aspect, the EDCA parameter may include one of the CWMIN parameter, the CWMAX parameter, or the AIFSN parameter, and the means for adjusting the EDCA parameter may be configured to increase the EDCA parameter in proportion to the signal strength or the distance. In another aspect, the EDCA parameter may include the TXOP parameter, and the means for adjusting the EDCA parameter may be configured to decrease the EDCA parameter in proportion to the signal strength or the distance. In another configuration, the means for adjusting the EDCA parameter may be configured to determine a normalized parameter based on the signal strength or the distance and to adjusting the EDCA parameter based on the normalized parameter and a range associated with the EDCA parameter. The range may include a maximum value and a minimum value. In another aspect, the normalized parameter may be determined based on the signal strength or the distance, a maximum parameter value associated with the signal strength or the distance, and a minimum parameter value associated with the signal strength or the distance. In another aspect, the normalized parameter may be a function of an energy detection (ED) level, a received signal strength indication (RSSI) between the access point and the apparatus, or the distance. In another configuration, the apparatus may include means for receiving information from the access point indicating at least one of the EDCA parameter to adjust or an EDCA parameter range for adjusting the EDCA parameter. In another configuration, the apparatus may include means for receiving an indicator enabling adjustment of the EDCA parameter, and the EDCA parameter may be adjusted after receiving the indicator. In another configuration, the apparatus may include means for receiving an indication that the access point supports EDCA parameter adjustment, and the EDCA parameter may be adjusted after receiving the indication. In another configuration, the EDCA parameter is adjusted based on the signal strength or the distance and based on an EDCA parameter lookup table. In this configuration, the EDCA parameter lookup table may include one or more EDCA parameters associated with the signal strength or the distance. In another configuration, the apparatus may include means for receiving, from the access point, information used by the apparatus for adjusting the EDCA parameter.

In another aspect, a computer-readable medium storing computer executable code for wireless communication by a station is provided. The computer-readable medium includes code for adjusting an EDCA parameter based on a signal strength of a signal from an access point or a distance between the station and the access point and for communicating with the access point based on the adjusted EDCA parameter. In an aspect, the EDCA parameter may include one of a CWMIN parameter, a CWMAX parameter, a AIFSN parameter, or a TXOP parameter. In another aspect, the EDCA parameter may include one of the CWMIN parameter, the CWMAX parameter, or the AIFSN parameter, and the code for adjusting the EDCA parameter may include code for increasing the EDCA parameter in proportion to the signal strength or the distance. In another aspect, the EDCA parameter may include the TXOP parameter, and the code for adjusting the EDCA parameter may include code for decreasing the EDCA parameter in proportion to the signal strength or the distance. In another configuration, the code for adjusting the EDCA parameter may include code for determining a normalized parameter based on the signal strength or the distance and for adjusting the EDCA parameter based on the normalized parameter and a range associated with the EDCA parameter. In this configuration, the range may include a maximum value and a minimum value. In another aspect, the normalized parameter may be determined based on the signal strength or the distance, a maximum parameter value associated with the signal strength or the distance, and a minimum parameter value associated with the signal strength or the distance. In another aspect, the normalized parameter may be a function of an ED level, an RSSI between the access point and the station, or the distance. In another configuration, the computer-readable medium may include code for receiving information from the access point indicating at least one of the EDCA parameter to adjust or an EDCA parameter range for adjusting the EDCA parameter. In another configuration, the computer-readable medium may include code for receiving an indicator enabling adjustment of the EDCA parameter, and the EDCA parameter may be adjusted after receiving the indicator. In another configuration, the computer-readable medium may include code for receiving an indication that the access point supports EDCA parameter adjustment, and the EDCA parameter may be adjusted after receiving the indication. In another configuration, the the EDCA parameter may be adjusted based on the signal strength or the distance and based on an EDCA parameter lookup table, and the EDCA parameter lookup table may include one or more EDCA parameters associated with the signal strength or the distance. In another configuration, the computer-readable medium may include code for receiving, from the access point, information used by the station for adjusting the EDCA parameter.

Another aspect of this disclosure provides an apparatus (e.g., an access point) for wireless communication. The apparatus is configured to determine whether the access point supports EDCA parameter adjustment and to transmit a message to a station based on the determination. The message indicating whether the access point supports EDCA parameter adjustment.

In another aspect, an apparatus for wireless communication is provided. The apparatus includes means for determining whether the apparatus supports EDCA parameter adjustment and means for transmitting a message to a station based on the determination. The message may indicate whether the apparatus supports EDCA parameter adjustment. In another configuration, the apparatus may include means for communicating with the station based on an EDCA parameter adjusted based on a signal strength of a signal communicated between the apparatus and the station or a distance between the apparatus and the station. In another aspect, the EDCA parameter may include one of a CWMIN parameter, a CWMAX parameter, an AIFSN parameter, or a TXOP parameter. In another configuration, the apparatus may include means for determining a signal strength of a signal communicated between the apparatus and the station or a distance between the apparatus and the station. In another configuration, the apparatus may include means for transmitting the determined signal strength or the determined distance to the station. In another configuration, the apparatus may include means for determining an EDCA parameter value for adjusting the EDCA parameter based on the determined signal strength or the determined distance and means for transmitting the determined EDCA parameter value for adjusting the EDCA parameter. In another configuration, the apparatus may include means for transmitting an EDCA parameter lookup table. The EDCA parameter lookup table may include one or more EDCA parameters associated with a signal strength of a signal communicated between the apparatus and the station or a distance between the apparatus and the station.

In another aspect, a computer-readable medium storing computer executable code for wireless communication by an access point is provided. The computer-readable medium may include code for determining whether the access point supports EDCA parameter adjustment and for transmitting a message to a station based on the determination. The message may indicate whether the access point supports EDCA parameter adjustment. In another configuration, the computer-readable medium may include code for communicating with the station based on an EDCA parameter adjusted based on a signal strength of a signal communicated between the access point and the station or a distance between the access point and the station. In an aspect, the EDCA parameter may include one of a CWMIN parameter, a CWMAX parameter, an AIFSN parameter, or a TXOP parameter. In another configuration, the computer-readable medium may include code for determining a signal strength of a signal communicated between the access point and the station or a distance between the access point and the station. In another configuration, the computer-readable medium may include code for transmitting the determined signal strength or the determined distance to the station. In another configuration, the computer-readaable medium may include code for determining an EDCA parameter value for adjusting the EDCA parameter based on the determined signal strength or the determined distance and for transmitting the determined EDCA parameter value for adjusting the EDCA parameter. In another configuration, the computer-readable medium may include code for transmitting an EDCA parameter lookup table. In this configuration, the EDCA parameter lookup table may include one or more EDCA parameters associated with a signal strength of a signal communicated between the access point and the station or a distance between the access point and the station.

### BRIEF DESCRIPTION OF THE DRAWINGS

FIG. 1 shows an example wireless communication system in which aspects of the present disclosure may be employed.

FIG. 2 is a diagram of a wireless network (e.g., a Wi-Fi network) using dynamic sensitivity control.

FIG. 3 is an exemplary diagram of a wireless network implementing adaptive EDCA adjustments for dynamic sensitivity control.

FIG. 4 shows a functional block diagram of an example wireless device that may adjust EDCA parameters for communicating within the wireless communication system of FIG. 1.

FIG. 5 is a flowchart of an example method of adjusting EDCA parameters for wireless communication.

FIG. 6 is a functional block diagram of an example wireless communication device that may adjust EDCA parameters.

FIG. 7 shows a functional block diagram of an example wireless device using adaptive EDCA that may be employed within the wireless communication system of FIG. 1.

FIG. 8 is a flowchart of an example method of wireless communication for adaptive EDCA.

FIG. 9 is a functional block diagram of an example wireless communication device for adaptive EDCA.

### DETAILED DESCRIPTION

Various aspects of the novel systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer program products, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of WLANs. A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct—sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations a STA may also be used as an AP.

An access point may also comprise, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A station may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations, a station may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the 802.11 standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

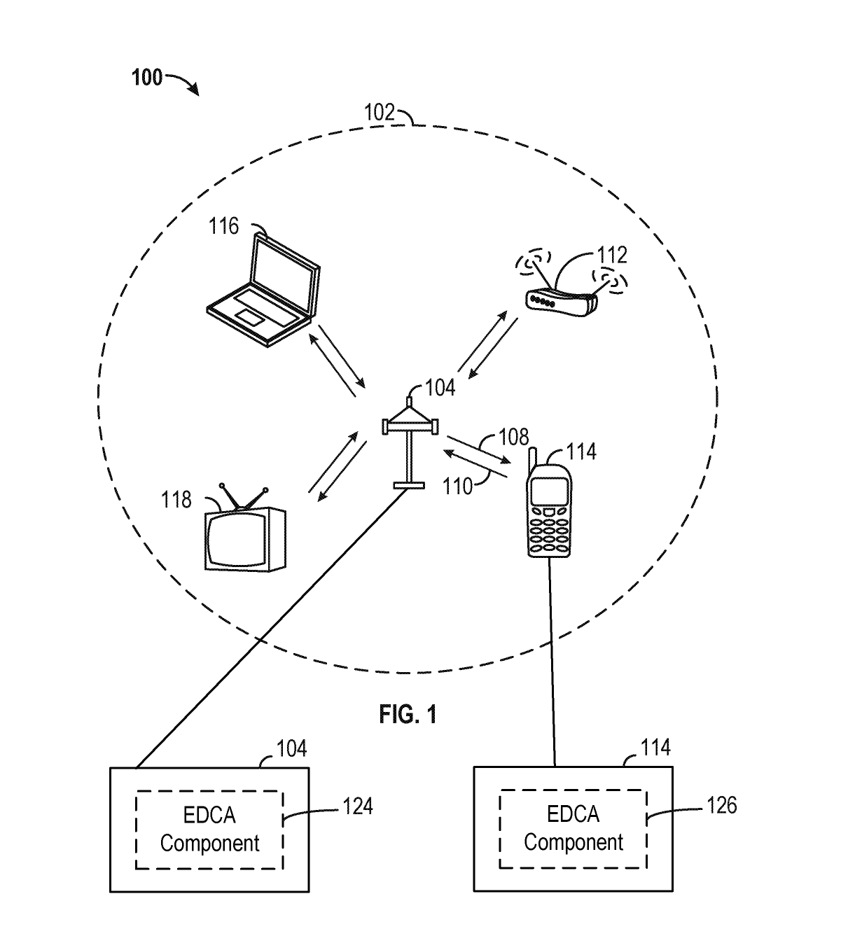

FIG. 1 shows an example wireless communication system 100 in which aspects of the present disclosure may be employed. The wireless communication system 100 may operate pursuant to a wireless standard, for example the 802.11 standard. The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) is the coverage area of an AP (e.g., the AP 104). The AP 104 along with the STAs associated with the AP 104 and that use the AP 104 for communication may be referred to as a basic service set (BSS). It should be noted that the wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 114) may be required to associate with the AP 104 in order to send communications to and/or to receive communications from the AP 104. In one aspect, information for associating is included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating, the STA 114 may transmit a reference signal, such as an association probe or request, to the AP 104. In some aspects, the AP 104 may use backhaul services, for example, to communicate with a larger network, such as the Internet or a public switched telephone network (PSTN).

In an aspect, the AP 104 may include one or more components for performing various functions. For example, the AP 104 may include an EDCA component 124 to perform procedures related to adjusting EDCA parameters. In this example, the EDCA component 124 may be configured to determine whether the AP 104 supports adaptive EDCA. The EDCA component 124 may be configured to transmit a message to a STA (e.g., the STA 114) based on the determination.

In another aspect, the STA 114 may include one or more components for performing various functions. For example, the STA 114 may include an EDCA component 126 to perform procedures related to adjusting EDCA parameters of the STA 114. In this example, the EDCA component 126 may be configured to adjust at least one EDCA parameter based on a communication parameter (e.g., a signal strength or a distance parameter). The EDCA component 126 may be configured to communicate with an AP (e.g., the AP 104) based on the at least one adjusted EDCA parameter.

In a Wi-Fi network, wireless devices such as APs and STAs may perform a clear channel assessment (CCA) to determine whether a transmission channel is busy or idle for purposes of determining whether data may be transmitted to another wireless device. A CCA has two components: carriers sense (CS) and energy detection. Carrier sense refers to an ability of a wireless device (e.g., AP or STA) to detect and decode incoming Wi-Fi signal preambles, signals which enable the receiver to acquire a wireless signal from and synchronize with the transmitter, from other wireless devices. For example, a first AP may broadcast a Wi-Fi signal preamble, and the Wi-Fi signal preamble may be detected by a second AP or a STA. Similarly, a third AP may broadcast a Wi-Fi signal preamble, and the Wi-Fi signal preamble may be detected by the second AP. When the second AP detects one or more of the Wi-Fi signal preambles, the second AP may determine that the transmission channel is busy and not transmit data. The CCA may remain busy for the length of a transmission frame associated with the Wi-Fi signal preambles.

The second component of CCA is energy detection, which refers to the ability of a wireless device to detect an energy level present on a transmission channel. The energy level may be based on different interference sources, Wi-Fi transmissions, a noise floor, and/or ambient energy. Wi-Fi transmissions may include unidentifiable Wi-Fi transmissions that have been corrupted or are so weak that the transmission can no longer be decoded. Unlike carrier sense, in which the exact length of time for which a transmission channel is busy may be known, energy detection uses periodic sampling of a transmission channel to determine if the energy still exists. Additionally, energy detection may require at least one threshold used to determine whether the reported energy level is adequate to report the transmission channel as busy or idle. This energy level may be referred to as the ED level/ED threshold level or the CCA sensitivity level. For example, if an ED level is above a threshold, a wireless device may defer to other devices by refraining from transmitting.

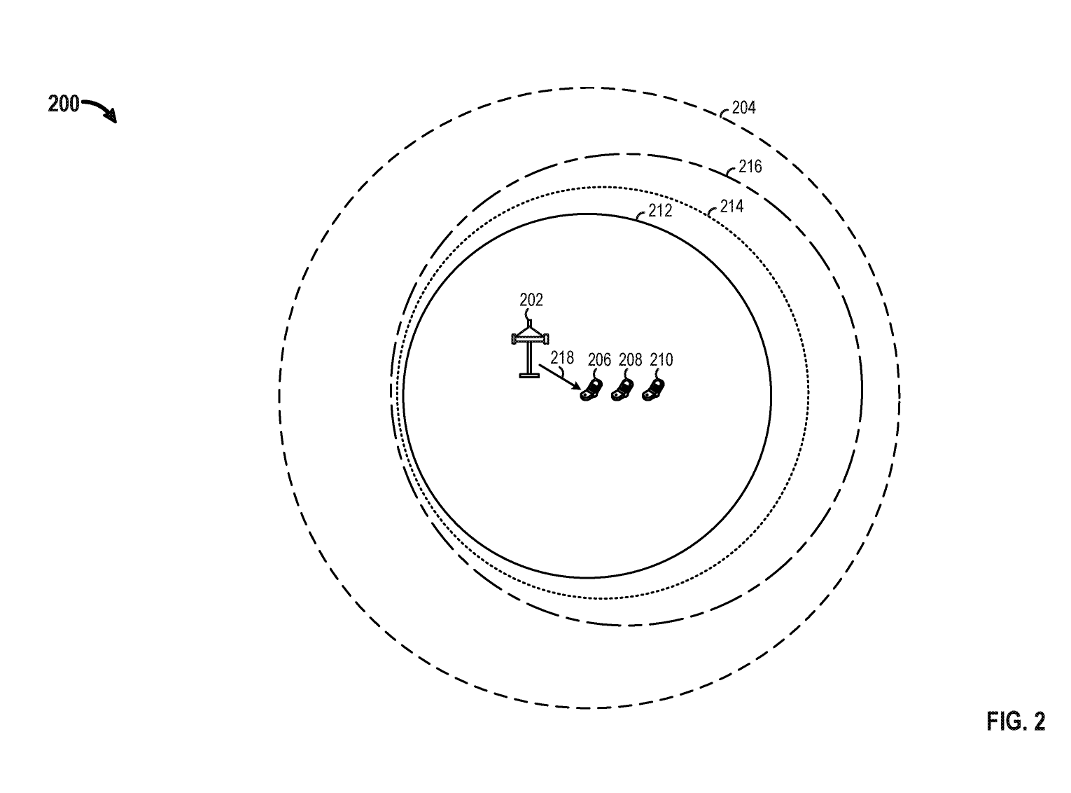

FIG. 2 is a diagram 200 of a wireless network (e.g., a Wi-Fi network) using dynamic sensitivity control. The diagram 200 illustrates an AP 202 broadcasting or transmitting within a BSA 204. The BSA 204 may encompass STAs 206, 208, 210 (or any other number of STAs). In an aspect, the STA 206 may be close in proximity to the AP 202 and thus be in the cell center. The STAs 206, 208, 210 may perform dynamic sensitivity control, which enables a STA to set an energy detection level (or ED level) based on an RSSI with the AP 202. In an aspect, an ED level may be determined based on the following equation (Eq. 1):

Energy Detection(ED)Level=max(min(RSS−M), EDmax), EDmin)

The ED level may be determined based on the RSSI, M, EDmax, and EDmin. The RSSI may be measured from a beacon message 218 received from the AP 202. Although FIG. 2 illustrates the beacon message 218 being transmitted to the STA 206, the STAs 208, 210 may also receive the beacon message 218. The value M may represent a tunable margin (or pre-configured back off value) that may be pre-configured within each STA or received in a management or action frame from the AP 202. EDmax represents the greatest ED level (e.g., −40 dBm) and EDmin represents the lowest ED level (e.g., −82 dBm) within an ED range for a STA. Dynamic sensitivity control enables STAs to defer to each other via the ED level. STAs closer to the AP 202 have higher ED levels for better reuse. Higher ED levels correspond to smaller energy deferrals areas. By contrast, lower ED levels correspond to larger energy deferral areas. For example, the STA 206 may be within a cell center of the BSA 204 and have a first energy deferral area 212. The STA 208, located further from the cell center than the STA 206, may have a lower ED level than the STA 206 and may have a second energy deferral area 214 that is larger than the energy deferral area 212. The STA 210, located further from the cell center than the STA 208, may have an ED level that is lower than the STA 208 and may have a third energy deferral area 216 that is larger than both the energy deferral areas 212, 214. As shown in FIG. 2, each of the STAs 206, 208, 210 is within the energy deferral areas of the other STAs. For example, the STA 206 is within the second and third energy deferral areas 214, 216 of the STAs 208, 210, respectively. As such, there are no hidden STAs (or nodes) within the BSS.

Referring back to FIG. 2, in a full buffer scenario (e.g., when the STAs 206, 208, 210 all have data to transmit to the AP 202), the STA 206, being closer to the cell center, may have a higher ED level and smaller energy deferral area (e.g., the energy deferral area 212) compared to the energy deferral areas 214, 216. As a result, the STA 206 may receive more air time compared to the STA 210 and other STAs closer to the edge of the BSA 204. For example, the STA 206 may not transmit if the STAs 208, 210 are transmitting because the STA 208, 210 are within the first energy deferral area 212 associated with the STA 206. The STA 210 may not transmit if the STAs 206, 208 are transmitting because the STAs 206, 208 are within the third energy deferral area 216 associated with the STA 210. Furthermore, because the third energy deferral area 216 is larger than the first energy deferral area 212, the STA 210 has a greater likelihood of deferring transmission. As such, between the STA 206 and the STA 210, the STA 210 may be less likely to transmit because the STA 210 has the larger energy deferral area. A need exists to increase the air time for STAs located toward the edge of the cell such that STAs near the edge of a cell are not starved of air time. One way to increase the air time for edge STAs is to use adaptive EDCA for dynamic sensitivity control.

By using EDCA, traffic is prioritized such that high priority traffic is more likely to be sent than low priority traffic. The EDCA mechanism defines four access categories: AC_BK, AC_BE, AC_VI, AC_VO (listed in order from lowest to highest priority). AC_BK represents background traffic, which may have the lowest priority. AC_BE represents traffic that may be sent using best efforts available at the time. AC_VI represents video traffic, and AC_VO represents voice traffic. A STA with higher priority traffic (e.g., AC_VO) may wait less before sending data compared to another STA with lower priority traffic (e.g., AC_BE).

Each of the four access categories may be associated with a set of four EDCA parameters: CWMIN (contention window minimum), CWMAX (contention window maximum), AIFSN (arbitration inter-frame space number), and TXOP (transmit opportunity). In an aspect, CWMIN may represent a minimum contention window (or a random amount of time) that a wireless device may need to back off before the wireless device may transmit data. In an aspect, the CWMIN may be similar to a counter. A larger CWMIN value means the wireless device needs to back off (or count) for a longer period of time before attempting to transmit data.

After a CWMIN period has passed, the wireless device may attempt to transmit data. If the transmission fails, the wireless device may increase the CWMIN value by a factor of 2 (e.g., CWMIN*2). The wireless device may wait for a period of CWMIN*2 and attempt to transmit the data again. If the transmission fails again, the wireless device may increase the CWMIN value by another factor of 2 (e.g., CWMIN*4). If the re-transmission fails again, the CWMIN will be further doubled until the new CWMIN value is greater than or equal to CWMAX, at which point CWMIN does not exceed CWMAX (and CWMIN may be set to CWMAX). AIFSN, which stands for arbitration inter-frame space number, may represent a fixed back off duration that occurs before the random back off of CWMIN. As such, a smaller AIFSN represents a smaller fixed back off. TXOP, or transmit opportunity, represents the data/data packet duration. A longer TXOP increases the air time for data transmission, which enables more data to be transmitted.

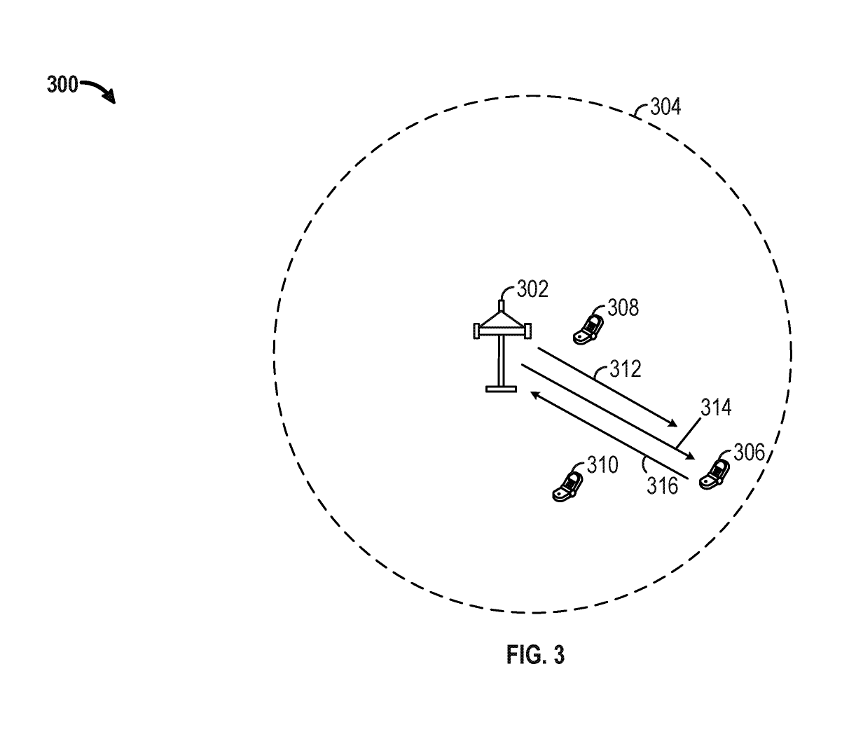

By using adaptive EDCA for DSC, STAs with lower ED levels or lower link RSSIs may choose more aggressive EDCA parameters, enabling edge STAs to have more air time. In this aspect, DSC is still preserved such that there are no hidden nodes. FIG. 3 illustrates several embodiments of adaptive EDCA.

FIG. 3 is an exemplary diagram 300 of a wireless network implementing adaptive EDCA adjustments for dynamic sensitivity control. The diagram 300 illustrates an AP 302 broadcasting or transmitting within a BSA 304. STAs 306, 308, 310 are within the BSA 304 and are served by the AP 302. As the STA 306 is the furthest away from the AP 302 compared to the STAs 308, 310, the STA 306 may receive less air time under dynamic sensitivity control compared to the STAs 308, 310. Among the STAs 306, 308, 310, the STA 306 may have the largest energy deferral area compared to the STAs 308, 310. To receive more air time, the STA 306 may adjust the EDCA aggressiveness based on a measured ED level. EDCA aggressiveness may be adjusted by choosing more aggressive EDCA parameters upon determining a lower ED level.

In one configuration, the STA 306 may autonomously adjust one or more EDCA parameters. In this configuration, the STA 306 may receive a first message 312 from the AP 302. The first message 312 may be a beacon message or some other data transmission (e.g., an action frame or management frame) from the AP 302. Based on the first message 312, the STA 306 may determine the RSSI between the STA 306 and the AP 302. Using the determined RSSI, the STA 306 may determine an ED level using Eq. 1:

ED Level=max(min(RSSI−M), EDmax), EDmin) (Eq. 1)

In an example, if the determined RSSI is −90 dBm, M is −25 dBm, EDmax is −40 dBm, and EDmin is −82 dBm, then the ED level will be −65 dBm. After computing the ED level based on dynamic sensitivity control, the STA 306 may determine or compute a normalized ED level based on the following equation:

$${η}_{ed} = \frac{ED - ED min}{ED max - ED min} \qquad ( Eq . 2 )$$

In Eq. 2, η_{ed} has a range of 0<η_{ed}<1. Assuming ED is −65 dBm, EDmin is −82 dBm, and EDmax is −40 dBm, then η_{ed} is approximately 0.40.

After determining η_{ed}, the STA 306 may adjust at least one EDCA parameter based on the normalized ED level. In an aspect, the normalized ED level, η_{ed}, may be used as a metric to compare ED levels amongst all STAs within a BSA. When η_{ed} is closer to 0, the ED level may be considered relatively low, and the STA 306 may choose a more aggressive EDCA parameter to receive more air time. By contrast, when η_{ed} is closer to 1, the ED level may be considered relatively high, and the STA 306 may choose a less aggressive EDCA parameter. In one aspect, the STA 306 may choose to adjust the CWMIN parameter. The CWMIN parameter may be bounded within a range of [CWMIN_{MIN}, CWMIN_{MAX}] (e.g., [15, 1023]). In Eq. 3 below, the STA 306 may adjust the CWMIN parameter to be a smaller value based on a lower η_{ed}:

CWMIN=CWMIN_{MIN}+(CWMIN_{MAX}−CWMIN_{MIN})×η_{ed} (Eq. 3)

Similar adjustments can be made with respect to the EDCA parameters, CWMAX and AIFSN. In an aspect, the CWMAX parameter may be bounded within a range [CWMAX_{MIN}, CWMAX_{MAX}] (e.g., [900,1100]). As shown in Eq. 4, like CWMIN, CWMAX may be adjusted based on η_{ed}:

CWMAX=CWMAX_{MIN}+(CWMAX_{MAX}−CWMAX_{MIN})×η_{ed} (Eq. 4)

In yet another aspect, AIFSN may be bounded within a range [AIFSN_{MIN}, AIFSN_{MAX}] (e.g., [0,10]). As shown in Eq. 5, AIFSN may be adjusted based on η_{ed}:

AIFSN=AIFSN_{MIN}+(AIFSN_{MAX}−AIFSN_{MIN})×η_{ed} (Eq. 5)

A fourth EDCA parameter, TXOP, may also be adjusted. TXOP may be bounded within a range of [TXOP_{MIN}, TXOP_{MAX}] (e.g., [0 ms, 5 ms]). TXOP may be adjusted to be a larger value for a lower η_{ed}. As shown in Eq. 6, TXOP may be adjusted based on η_{ed}:

TXOP=TXOP_{MAX}−(TXOP_{MAX}−TXOP_{MIN})×η_{ed} (Eq. 6)

In an aspect, the STA 306 may adjust one or more of the above EDCA parameters based on η_{ed}. In another aspect, the STA 306 may adjust one or more of the EDCA parameters when η_{ed} is less than threshold (e.g., 0.50) and not adjust the EDCA parameters otherwise. Additionally, although the foregoing only discloses the STA 306 adjusting the EDCA parameters, other STAs (e.g., the STAs 308, 310) may also receive the first message 312 and adjust at least one EDCA parameter based on the determined η_{ed}.

In another configuration, instead of autonomously adjusting one or more EDCA parameters based on a normalized ED level, the STA 306 may autonomously adjust one or more EDCA parameters based on a normalized RSSI. As previously discussed, the STA 306 may determine an RSSI value between the STA 306 and the AP 302 based on the received first message 312. The first message 312 may be an AP beacon or some other message. The RSSI may be constrained within a range [RSSI_{MUN}, RSSI_{MAX}] (e.g., [−120 dBm, −50 dBm]) such that RSSI may be set to RSSI_{MIN} if RSSI is less than RSSI_{MIN}. Similarly, RSSI may be set to RSSI_{MAX} if RSSI is greater than RSSI_{MAX}. With a constrained RSSI as an input, the normalized RSSI, ηᵣₛₛᵢ may be determined based on Eq. 7:

$${η}_{rssi} = \frac{RSSI - RSSI min}{RSSI max - RSSI min} \qquad ( Eq . 7 )$$

Like η_{ed}, ηᵣₛₛᵢ, has a range of 0<ηᵣₛₛᵢ<1. When ηᵣₛₛᵢ is closer to 0, the STA 306 may be closer to the cell edge, and the STA 306 may choose a more aggressive EDCA parameter to receive more air time. By contrast, when ηᵣₛₛᵢ is closer to 1, the STA 306 may be closer to the cell center, and the STA 306 may choose a less aggressive EDCA parameter. After determining ηᵣₛₛᵢ, the STA 306 may adjust one or more EDCA parameters based on the determined ηᵣₛₛᵢ. Similar to Eqs. 3-6, the EDCA parameters—CWMIN, CWMAX, AIFSN, and TXOP—may be adjusted based on ηᵣₛₛᵢ by the following equations:

CWMIN=CWMIN_{MIN}+(CWMIN_{MAX}−CWMIN_{MIN})×ηᵣₛₛᵢ (Eq. 8)

CWMAX=CWMAX_{MIN}+(CWMAX_{MAX}−CWMAX_{MIN})×ηᵣₛₛᵢ (Eq. 9)

AIFSN=AIFSN_{MIN}+(AIFSN_{MAX}−AIFSN_{MIN})×ηᵣₛₛᵢ (Eq. 10)

TXOP=TXOP_{MAX}−(TXOP_{MAX}−TXOP_{MIN})×ηᵣₛₛᵢ (Eq. 11)

In another configuration, instead of autonomously adjusting one or more EDCA parameters based on an ED level or RSSI, the STA 306 may autonomously adjust one or more EDCA parameters based on a normalized distance between the STA 306 and the AP 302. The STA 306 may determine a distance between the STA 306 and the AP 302 based on the received first message 312. The first message 312 may be an AP beacon or some other message. The distance, D, may be constrained within a range [D_{MIN}, D_{MAX}] (e.g., [1 m, 100 m]) such that D may be set to D_{MIN} if D is less than D_{MIN}. In an aspect, D_{MAX} may be a distance from the cell edge of the BSA 304. The STA 306 may determine D in at least two ways. In one aspect, the STA 306 may have a lookup table the correlates RSSI to distance. The STA 306 may determine the RSSI value based on the received first message 312, and compare the RSSI value to a lookup table to determine D. As such, the lowest RSSI may correspond to D_{MAX}, while the highest RSSI may correspond to D_{MIN}. In another aspect, the STA 306 may determine the distance from the AP 302 based on the GPS coordinates of the AP 302, which may be broadcast by the AP 302 in the first message 312. With a constrained D as an input, the normalized D, η_{d} may be determined based on Eq. 12:

$${η}_{d} = \frac{D - D min}{D max - D min} \qquad ( Eq . 12 )$$

After determining η_{d}, the STA 306 may adjust one or more EDCA parameters based on the determined η_{d}. The EDCA parameters—CWMIN, CWMAX, AIFSN, and TXOP—may be determined by the following equations:

CWMIN=CWMIN_{MIN}+(CWMIN_{MAX}−CWMIN_{MIN})×η_{d} (Eq. 13)

CWMAX=CWMAX_{MIN}+(CWMAX_{MAX}−CWMAX_{MIN})×η_{d} (Eq. 14)

AIFSN=AIFSN_{MIN}+(AIFSN_{MAX}−AIFSN_{MIN})×η_{d} (Eq. 15)

TXOP=TXOP_{MAX}−(TXOP_{MAX}−TXOP_{MIN})×η_{d} (Eq. 16)

In an aspect, in the above examples, the STA 306 may use the adjusted EDCA parameter for transmission when the measured energy on a channel is less than the ED level threshold. When the measured energy is less than the ED level, the adjusted EDCA parameter enables the STA 306 to be more aggressive with respect to obtaining air time for data transmission. However, when the measured energy level is greater than the ED level, the STA 306 may continue to defer transmissions for a period of time until the channel is less busy.

In another configuration, the AP 302 may provide signaling to the STA 306 for purposes of implementing adaptive EDCA adjustments. In this configuration, the AP 302 may transmit a second message 314 to the STA 306. The second message 314 may be a management frame, an action frame, or a trigger frame. In an aspect, the second message 314 may indicate a set of EDCA parameters allowed for adjustment and/or an adjustment range per EDCA parameter for each access category. For example, the second message 314 may indicate to the STA 306 or instruct the STA 306 to adjust the CWMIN and TXOP parameters. In another example, the second message 314 may indicate to the STA 306 or instruct the STA 306 to adjust the CWMIN adjustment range to be within [15, 800]. In another aspect, the first message 312 need not be received before the second message 314.

In another aspect, the second message 314 may include an indicator for enabling adaptive EDCA (e.g., the second message 314 may be a management frame or an action frame). For example, the STA 306 may be capable of supporting adaptive EDCA adjustments, but the functionality may be disabled. The AP 302 may transmit the second message 314 to the STA 306, and the second message 314 may instruct the STA 306 to enable adaptive EDCA. The second message 314 may be broadcast, multicast, or unicast to the STA 306. In an aspect, the AP 302 may signal an edge STA (e.g., the STA 306) to enable adaptive EDCA when the STA 306 has air time that is less than a threshold (e.g., 1 ms per minute). The AP 302 may determine the amount of air time for the STA 306 by receiving a report from the STA 306. The report may indicate the amount of air time that the STA 306 has received over a period of time. In another scenario, the AP 302 may signal an air time threshold in the second message 314. Based on the received threshold, and by comparing the received threshold to a current amount of air time received, the STA 306 may determine whether to enable adaptive EDCA.

In another aspect, the AP 302 and the STA 306 may each indicate a capability to support adaptive EDCA. The AP 302 may indicate a capability to support adaptive EDCA in the first message 312 and/or the second message 314. The STA 306 may transmit a third message 316 to the AP 302 to indicate a capability to support adaptive EDCA (e.g., the third message 316 may be an association request or management frame). In an aspect, the STA 306 may send the third message 316 to the AP 302 in response to receiving the first message 312 and/or the second message 314. In another scenario, the AP 302 may transmit the first message 312 and/or the second message 314 in response to receiving the third message 316 from the STA 306. The STA 306 may select the AP 302 after receiving an indication that the AP 302 supports adaptive EDCA adjustments. For example, if the STA 306 is within range of multiple APs, but only the AP 302 has indicated that the AP 302 supports adaptive EDCA, then the STA 306 may associate with the AP 302 based on the indication. In another aspect, the AP 302 may only request a STA capable of supporting adaptive EDCA to enable adaptive EDCA.

In another configuration, instead of dynamically computing EDCA based on an ED level, an RSSI, or a distance from the AP 302, the STA 306 may select a pre-configured EDCA value mapped to a current ED level, RSSI, or distance. For example, if the currently ED level is within a range [−72, −82] dBm, the STA 306 may chose CWMIN=31. In an aspect, the STA 306 may use a lookup table that has various ED level, RSSI, and or distance values corresponding or correlated to various EDCA parameters. Based on a current ED level, RSSI, or distance, the STA 306 selects a suitable EDCA parameter. In this configuration, the STA 306 may not need to perform any calculations to determine an appropriate EDCA parameter. In another aspect, the lookup table may be transmitted by the AP 302 to the STA 306 in the first and/or second messages 312, 314.

In another configuration, the AP 302 may dynamically signal to the STA 306 the ED level and/or an EDCA parameter value for every adjustment based on a current link RSSI or distance between the AP 302 and the STA 306. In an aspect, the AP 302 may determine the link RSSI based on a beacon RSSI report received from the STA 306 or by measuring the uplink RSSI with data packets received from the STA 306. In another aspect, the AP 302 may require the STA 306 to periodically report a link RSSI or transmit uplink data packets. In another aspect, the AP 302 may require the STA 306 to report a link RSSI if the RSSI value has changed beyond a threshold (e.g., 5 dBm). In another aspect, the AP 302 may determine the link RSSI based on a distance between the AP 302 and the STA 306 (e.g., using GPS coordinates). The AP 302 may correlate the distance with a RSSI value based on a lookup table.

After determining the RSSI, the AP 302 may compute the ED level (e.g., by using Eq. 1, above). Having determined the ED level, the AP 302 may determine new EDCA parameter values based on the aforementioned equations (e.g., Eqs. 2-6). Next, the AP 302 may transmit the computed ED level and/or the EDCA parameter values to the STA 306 in the second message 314. The AP 302 may transmit new ED levels and/or new EDCA parameter values if the RSSI between the AP 302 and the STA 306 changes beyond a threshold (e.g., 5 dBm). Although the aforementioned example discloses computing an EDCA parameter value based on an ED level, an EDCA parameter value may be computed based on distance or RSSI. Having adjusted at least one EDCA parameter, the STA 306 may communicate with the AP 302 based on the at least one adjusted EDCA parameter.

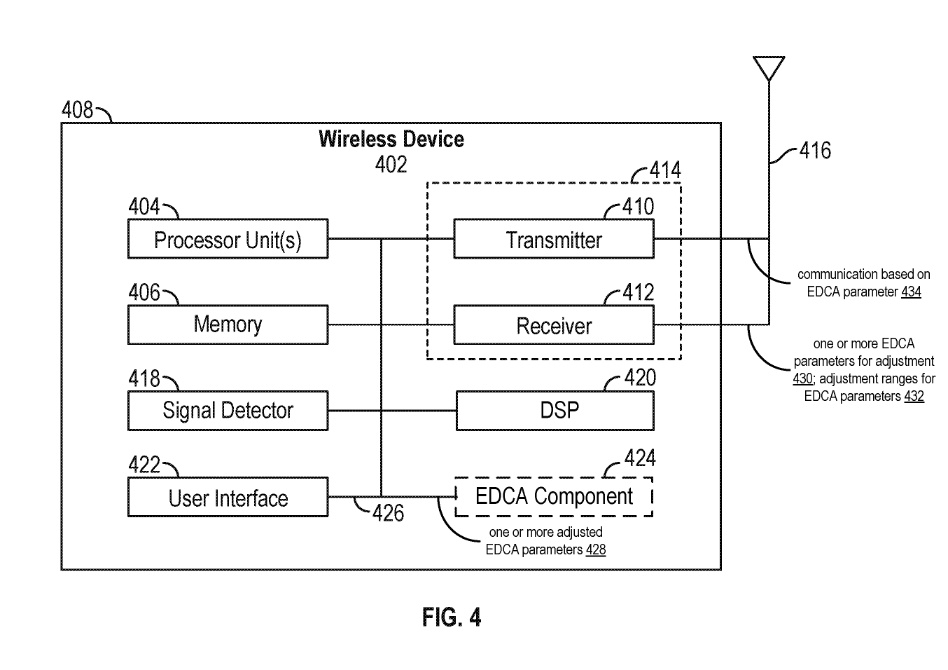

FIG. 4 shows an example functional block diagram of a wireless device 402 that may adjust EDCA parameters for communicating within the wireless communication system 100 of FIG. 1. The wireless device 402 is an example of a device that may be configured to implement the various methods described herein. For example, the wireless device 402 may comprise one of the STAs 112, 114, 116, and 118.

The wireless device 402 may include a processor 404 which controls operation of the wireless device 402. The processor 404 may also be referred to as a central processing unit (CPU). Memory 406, which may include both read-only memory (ROM) and random access memory (RAM), may provide instructions and data to the processor 404. A portion of the memory 406 may also include non-volatile random access memory (NVRAM). The processor 404 typically performs logical and arithmetic operations based on program instructions stored within the memory 406. The instructions in the memory 406 may be executable (by the processor 404, for example) to implement the methods described herein.

The processor 404 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 402 may also include a housing 408, and the wireless device 402 may include a transmitter 410 and/or a receiver 412 to allow transmission and reception of data between the wireless device 402 and a remote device. The transmitter 410 and the receiver 412 may be combined into a transceiver 414. An antenna 416 may be attached to the housing 408 and electrically coupled to the transceiver 414. The wireless device 402 may also include multiple transmitters, multiple receivers, multiple transceivers, and/or multiple antennas.

The wireless device 402 may also include a signal detector 418 that may be used to detect and quantify the level of signals received by the transceiver 414 or the receiver 412. The signal detector 418 may detect such signals as total energy, energy per subcarrier per symbol, power spectral density, and other signals. The wireless device 402 may also include a DSP 420 for use in processing signals. The DSP 420 may be configured to generate a packet for transmission. In some aspects, the packet may comprise a physical layer convergence procedure (PLCP) protocol data unit (PPDU).

The wireless device 402 may further comprise a user interface 422 in some aspects. The user interface 422 may comprise a keypad, a microphone, a speaker, and/or a display. The user interface 422 may include any element or component that conveys information to a user of the wireless device 402 and/or receives input from the user.

When the wireless device 402 is implemented as a STA (e.g., STA 114 or STA 306), the wireless device 402 may also comprise an EDCA component 424. The EDCA component 424 may be configured to adjust at least one EDCA parameter (e.g., one or more adjusted EDCA parameters 428) based on a communication parameter. The EDCA component 424 may be configured to communicate with an access point based on the at least one adjusted EDCA parameter (e.g., communication based on an EDCA parameter 434). In one configuration, the EDCA component 424 may be configured to adjust the at least one EDCA parameter by determining a normalized communication parameter based on the communication parameter, and adjusting the at least one EDCA parameter based on the normalized communication parameter and a range associated with each of the at least one EDCA parameter. In this configuration, the range may include a maximum value and a minimum value. In an aspect, the normalized communication parameter may be determined based on the communication parameter, a maximum parameter value associated with the communication parameter, and a minimum parameter value associated with the communication parameter. In another configuration, the EDCA component 424 may be configured to adjust the at least one EDCA parameter based on the communication parameter and an EDCA parameter lookup table. In this configuration, the EDCA parameter lookup table may include one or more EDCA parameters associated with the communication parameter. In an aspect, the communication parameter may be an ED level, an RSSI between the wireless device 402 and the access point, or a distance between the wireless device 402 and the access point. In another configuration, when the communication parameter is an ED level, the communication parameter may be based on the RSSI, a backoff value, a maximum ED level, and a minimum ED level. In another aspect, the at least one EDCA parameter may include a CWMIN, a CWMAX, an AIFSN, or a TXOP. In another configuration, the EDCA component 424 may be configured to receive a message from the access point. The message may indicate one or more EDCA parameters allowed for adjustment (e.g., one or more EDCA parameters for adjustment 430) and an adjustment range for each of the one or more EDCA parameters (e.g., adjustment ranges for EDCA parameters 432). In another configuration, the EDCA component 424 may be configured to receive a message from the access point. The message may include an indicator for enabling adaptive EDCA. In another configuration, the EDCA component 424 may be configured to transmit a message to the access point. The message may indicate whether the wireless device 402 is capable adaptive EDCA. In another configuration, the EDCA component 424 may be configured to receive a message from the access point. The message may include the communication parameter or an EDCA value for each of the at least one EDCA parameter to be adjusted. The EDCA value may be based on the communication parameter, and the at least one EDCA parameter may be adjusted based on the message.

The various components of the wireless device 402 may be coupled together by a bus system 426. The bus system 426 may include a data bus, for example, as well as a power bus, a control signal bus, and a status signal bus in addition to the data bus. Components of the wireless device 402 may be coupled together or accept or provide inputs to each other using some other mechanism.

Although a number of separate components are illustrated in FIG. 4, one or more of the components may be combined or commonly implemented. For example, the processor 404 may be used to implement not only the functionality described above with respect to the processor 404, but also to implement the functionality described above with respect to the signal detector 418, the DSP 420, the user interface 422, and/or the EDCA component 424. Further, each of the components illustrated in FIG. 4 may be implemented using a plurality of separate elements.

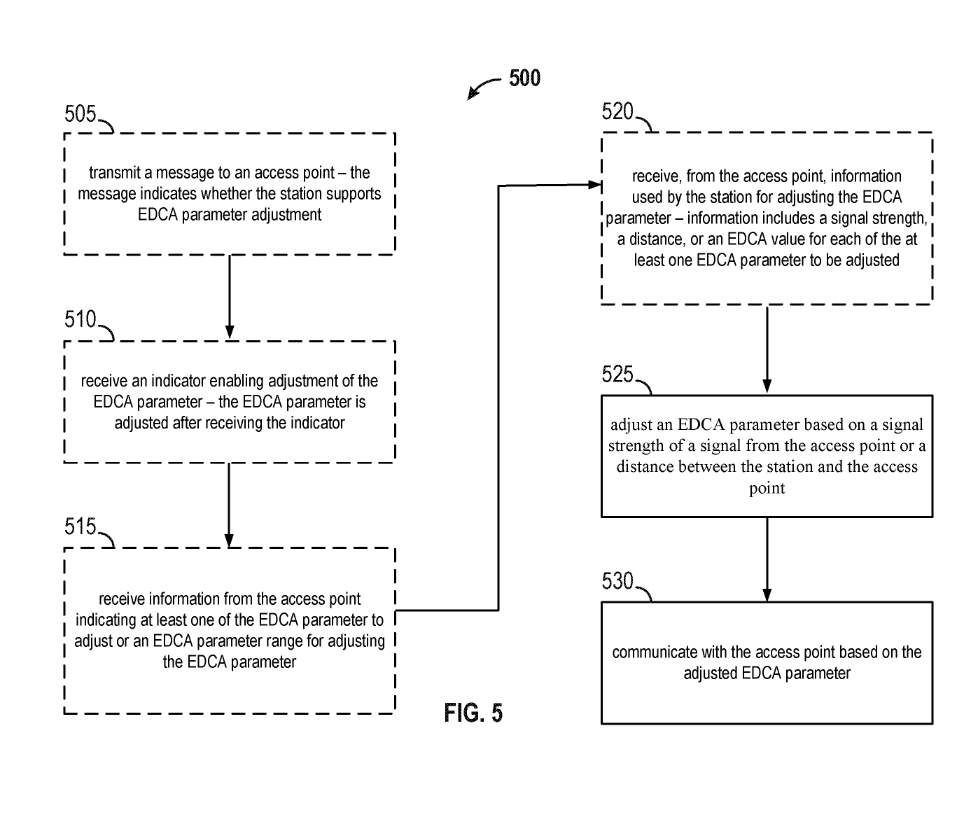

FIG. 5 is a flowchart of an example method 500 of adjusting EDCA parameters for wireless communication. The method 500 may be performed using an apparatus (e.g., the STA 114, the STA 306, 308, 310, or the wireless device 402, for example). Although the method 500 is described below with respect to the elements of wireless device 402 of FIG. 4, other components may be used to implement one or more of the steps described herein.

At block 505, the apparatus may transmit a message to an access point. The message may indicate whether the apparatus is supports EDCA parameter adjustment. For example, referring to FIG. 3, the STA 306 may transmit a third message 316 to the AP 302. The third message 316 may indicate that the STA 306 is capable of adaptive EDCA.

At block 510, the apparatus may receive an indicator enabling adjustment of EDCA parameters. The EDCA parameter may be adjusted after receiving the indicator. For example, referring to FIG. 3, the STA 306 may receive the second message 314 from the AP 302. The second message 314 may include an indicator for enabling adaptive EDCA at the STA 306, and the STA 306 may adjust one or more EDCA parameters after receiving the second message 314.

At block 515, the apparatus may receive information from the access point indicating at least one of the EDCA parameter to adjust or an EDCA parameter range for adjusting the EDCA parameter. For example, the STA 306 may receive the second message 314 from the AP 302. The second message 314 may indicate to the STA 306 to adjust the CWMAX. In another example, the second message 314 may indicate to the STA 306 to adjust the CWMIN parameter between a range of [100,150].

At block 520, the apparatus may receive, from the access point, information used by the apparatus for adjusting the EDCA parameter. The information may include a signal strength, a distance, or an EDCA value for each of the at least one EDCA parameter to be adjusted. For example, the STA 306 may receive the second message 314 from the AP 302. In one aspect, the second message 314 may include an ED level to be used by the STA 306 for adjusting the CWMIN and CWMAX, for example. The STA 306 may adjust the CWMIN and the CWMAX based on the ED level received in the second message 314. In another aspect, the second message 314 may include a CWMIN value of 20 and a CWMAX value of 1000. The STA 306 may adjust the CWMIN and CWMAX values based on the corresponding values received in the second message 314. The CWMIN and CWMAX values, transmitted by the AP 302, may be based on an ED level, an RSSI between the AP 302 and the STA 306, or a distance between the AP 302 and the STA 306.

In an aspect, one or more of the blocks 505-520 may be optional and may not be performed by the apparatus for purposes of adaptive EDCA.

At block 525, the apparatus may adjust an EDCA parameter based on a signal strength of a signal from the access point or a distance between the apparatus and the access point. The apparatus may adjust the at least one EDCA parameter by determining a normalized parameter based on the signal strength or the distance and by adjusting the at least one EDCA parameter based on the normalized parameter and a range associated with the EDCA parameter. The range may include a maximum value and a minimum value. In one configuration, the normalized parameter may be determined based on the signal strength or the distance, a maximum parameter value associated with the signal strength or the distance, and a minimum parameter value associated with the signal strength or the distance. In an aspect, the signal strength may be an ED level or an RSSI between the apparatus and the access point. In another aspect, the EDCA parameter may include a CWMIN, a CWMAX, an AIFSN, or a TXOP.

For example, referring to FIG. 3, the STA 306 may adjust a CWMIN and TXOP parameter based on an RSSI. The STA 306 may adjust the CWMIN and TXOP by determining a normalized RSSI based on the RSSI and by adjusting the CWMIN and TXOP based on the normalized RSSI and a range associated with each of the CWMIN and TXOP. In this example, a range [10, 1000] may be associated with the CWMIN and a range [1 ms, 3 ms] may be associated with the TXOP.

In another example, referring to FIG. 3, the STA 306 may adjust a AIFSN parameter based on an ED level. The STA 306 may adjust the AIFSN by determining a normalized ED level based on the ED level and by adjusting the AIFSN based on the normalized ED level and a range associated with the AIFSN. In this example, a range [5, 20] may be associated with the AIFSN. The ED level may be determined based on the RSSI, M, EDmax, and EDmin.

In another configuration, the adjusting the EDCA parameter may be based on the an EDCA parameter lookup table. The EDCA parameter lookup table may include one or more EDCA parameters associated with the communication parameter. For example, the STA 306 may adjust a CWMIN parameter based on an ED level and an EDCA parameter lookup table. The lookup table may indicate that for an ED level of −50 dBm, CWMIN should be set to 500. But for an ED level of −70 dBm, CWMIN should be set to 100. In another example, the lookup table may indicate that for an ED level of −50 dBm, CWMIN should be within a range of [300,1000]. And for an ED level of −70 dBm, CWMIN should be within a range of [50,250].

At block 530, the apparatus may communicate with an access point based on the at least one adjusted EDCA parameter. For example, the STA 306 may communicate with the AP 302 based on the adjusted CWMIN parameter.

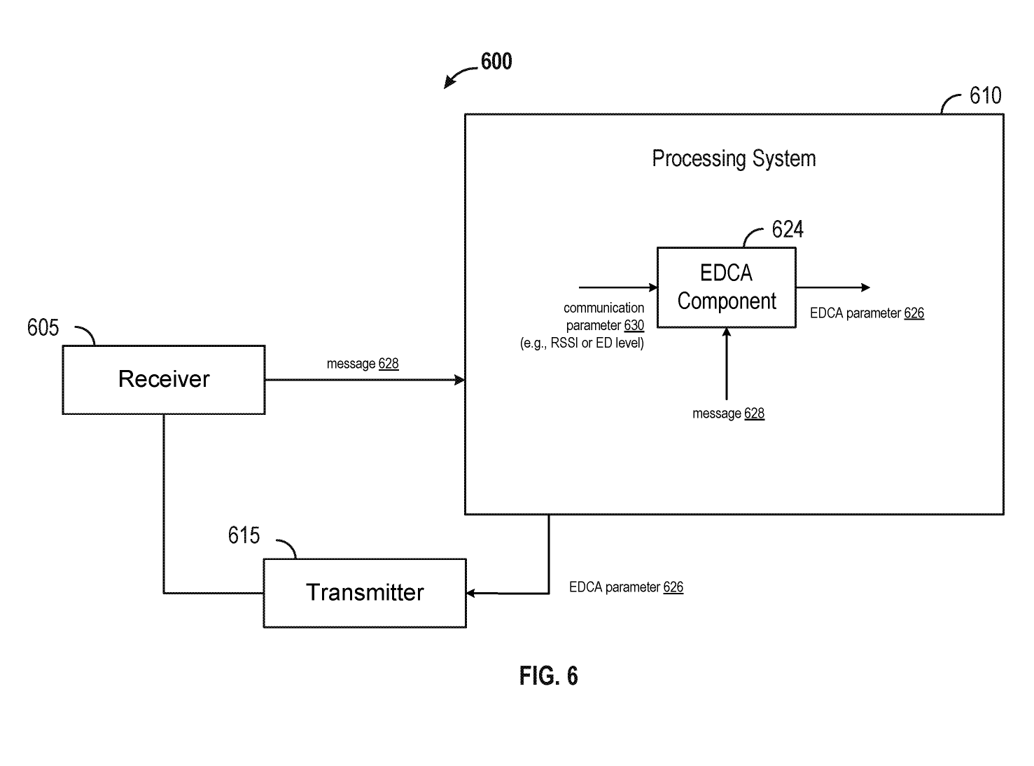

FIG. 6 is a functional block diagram of an example wireless communication device 600 that may adjust EDCA parameters. The wireless communication device 600 may include a receiver 605, a processing system 610, and a transmitter 615. The processing system 610 may include an EDCA component 624. The processing system 610 and/or the EDCA component 624 may be configured to adjust at least one EDCA parameter based on a communication parameter (e.g., communication parameter 630 such as an RSSI or ED level). The processing system 610, the EDCA component 624, and/or the transmitter 615 may be configured communicate with an access point based on the at least one adjusted EDCA parameter (e.g., EDCA parameter 626). In one configuration, the processing system 610 and/or the EDCA component 624 may be configured to adjust the at least one EDCA parameter by determining a normalized communication parameter based on the communication parameter and by adjusting the at least one EDCA parameter based on the normalized communication parameter and a range associated with each of the at least one EDCA parameter. The range may include a maximum value and a minimum value. In an aspect, the normalized communication parameter may be determined based on the communication parameter, a maximum parameter value associated with the communication parameter, and a minimum parameter value associated with the communication parameter. In another configuration, the processing system 610 and/or the EDCA component 624 may be configured to adjust the at least one EDCA parameter based on the communication parameter and an EDCA parameter lookup table. The EDCA parameter lookup table may include one or more EDCA parameters associated with the communication parameter. In an aspect, the communication parameter may be an ED level, an RSSI between the wireless communication device 600 and the access point, or a distance between the wireless communication device 600 and the access point. In another aspect, when the communication parameter is an ED level, the communication parameter may be based on the RSSI, a backoff value, a maximum ED level, and a minimum ED level. In another aspect, the at least one EDCA parameter may include a CWMIN, a CWMAX, an AIFSN, or a TXOP. In another configuration, the processing system 610, the EDCA component 624, and/or the receiver 605 may be configured to receive a message (e.g., a message 628) from the access point. The message may indicate one or more EDCA parameters allowed for adjustment and an adjustment range for each of the one or more EDCA parameters. In another configuration, the processing system 610, the EDCA component 624, and/or the receiver 605 may be configured to receive a message from the access point, and the message may include an indicator for enabling adaptive EDCA. In another configuration, the processing system 610, the EDCA component 624, and/or the transmitter 615 may be configured to transmit a message to the access point, and the message may indicate whether the wireless communication device 600 is capable adaptive EDCA. In another configuration, the processing system 610, the EDCA component 624, and/or the receiver 605 may be configured to receive a message from the access point. The message may include the communication parameter or an EDCA value for each of the at least one EDCA parameter to be adjusted. In this configuration, the EDCA value may be based on the communication parameter, and the at least one EDCA parameter may be adjusted based on the message.

The receiver 605, the processing system 610, the EDCA component 624, and/or the transmitter 615 may be configured to perform one or more functions discussed above with respect to blocks 505, 510, 515, 520, 525, and 530 of FIG. 5. The receiver 605 may correspond to the receiver 412. The processing system 610 may correspond to the processor 404. The transmitter 615 may correspond to the transmitter 410. The EDCA component 624 may correspond to the EDCA component 126 and/or the EDCA component 424.

In one configuration, the wireless communication device 600 may include means for adjusting an EDCA parameter based on a signal strength of a signal from an access point or a distance between the apparatus and the access point. The wireless communication device 600 may include means for communicating with the access point based on the adjusted EDCA parameter. In an aspect, the EDCA parameter may include one of a CWMIN parameter, a CWMAX parameter, an AIFSN parameter, or a TXOP parameter. In another aspect, the EDCA parameter may include one of the CWMIN parameter, the CWMAX parameter, or the AIFSN parameter, and the means for adjusting the EDCA parameter may be configured to increase the EDCA parameter in proportion to the signal strength or the distance. In another aspect, the EDCA parameter may include the TXOP parameter, and the means for adjusting the EDCA parameter may be configured to decrease the EDCA parameter in proportion to the signal strength or the distance. In another configuration, the means for adjusting the EDCA parameter may be configured to determine a normalized parameter based on the signal strength or the distance and to adjusting the EDCA parameter based on the normalized parameter and a range associated with the EDCA parameter. The range may include a maximum value and a minimum value. In another aspect, the normalized parameter may be determined based on the signal strength or the distance, a maximum parameter value associated with the signal strength or the distance, and a minimum parameter value associated with the signal strength or the distance. In another aspect, the normalized parameter may be a function of an ED level, an RSSI between the access point and the apparatus, or the distance. In another configuration, the wireless communication device 600 may include means for receiving information from the access point indicating at least one of the EDCA parameter to adjust or an EDCA parameter range for adjusting the EDCA parameter. In another configuration, the wireless communication device 600 may include means for receiving an indicator enabling adjustment of the EDCA parameter, and the EDCA parameter may be adjusted after receiving the indicator. In another configuration, the wireless communication device 600 may include means for receiving an indication that the access point supports EDCA parameter adjustment, and the EDCA parameter may be adjusted after receiving the indication. In another configuration, the EDCA parameter is adjusted based on the signal strength or the distance and based on an EDCA parameter lookup table. In this configuration, the EDCA parameter lookup table may include one or more EDCA parameters associated with the signal strength or the distance. In another configuration, the wireless communication device 600 may include means for receiving, from the access point, information used by the apparatus for adjusting the EDCA parameter.

For example, means for adjusting at least one EDCA parameter may include the processing system 610 and/or the EDCA component 624. Means for communicating with an access point may include the processing system 610, the EDCA component 624, the receiver 605, and/or the transmitter 615. Means for receiving a message may include the processing system 610, the EDCA component 624, and/or the receiver 605.

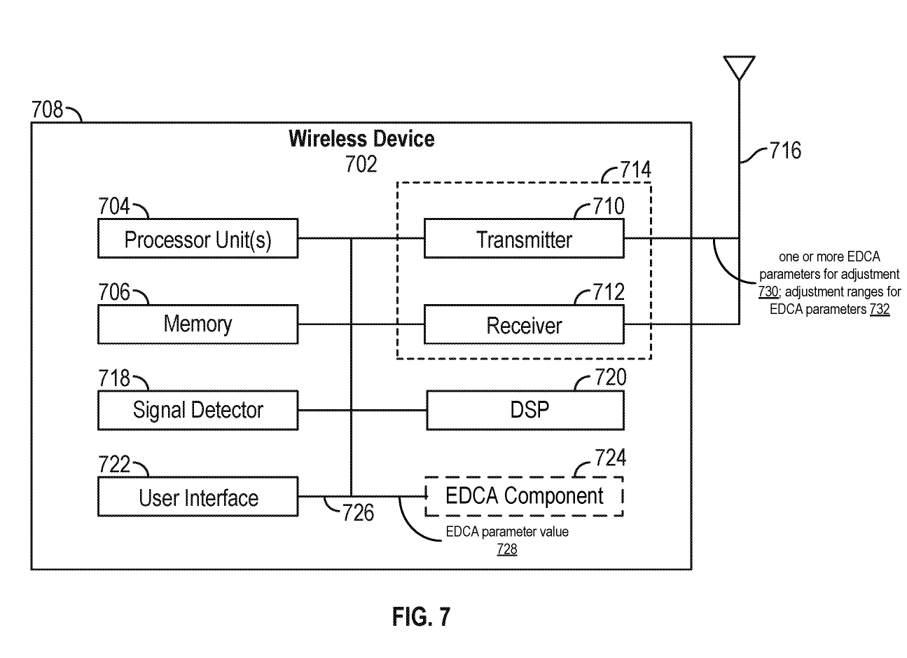

FIG. 7 shows an example functional block diagram of a wireless device 702 using adaptive EDCA that may be employed within the wireless communication system 100 of FIG. 1. The wireless device 702 is an example of a device that may be configured to implement the various methods described herein. For example, the wireless device 702 may comprise the AP 104 or the AP 302.

The wireless device 702 may include a processor 704 which controls operation of the wireless device 702. The processor 704 may also be referred to as a CPU. Memory 706, which may include both ROM and RAM, may provide instructions and data to the processor 704. A portion of the memory 706 may also include NVRAM. The processor 704 typically performs logical and arithmetic operations based on program instructions stored within the memory 706. The instructions in the memory 706 may be executable (by the processor 704, for example) to implement the methods described herein.

The processor 704 may comprise or be a component of a processing system implemented with one or more processors. The one or more processors may be implemented with any combination of general-purpose microprocessors, microcontrollers, DSPs, FPGAs, PLDs, controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 702 may also include a housing 708, and the wireless device 702 may include a transmitter 710 and/or a receiver 712 to allow transmission and reception of data between the wireless device 702 and a remote device. The transmitter 710 and the receiver 712 may be combined into a transceiver 714. An antenna 716 may be attached to the housing 708 and electrically coupled to the transceiver 714. The wireless device 702 may also include multiple transmitters, multiple receivers, multiple transceivers, and/or multiple antennas.

The wireless device 702 may also include a signal detector 718 that may be used to detect and quantify the level of signals received by the transceiver 714 or the receiver 712. The signal detector 718 may detect such signals as total energy, energy per subcarrier per symbol, power spectral density, and other signals. The wireless device 702 may also include a DSP 720 for use in processing signals. The DSP 720 may be configured to generate a packet for transmission. In some aspects, the packet may comprise a PPDU.

The wireless device 702 may further comprise a user interface 722 in some aspects. The user interface 722 may comprise a keypad, a microphone, a speaker, and/or a display. The user interface 722 may include any element or component that conveys information to a user of the wireless device 702 and/or receives input from the user.

When the wireless device 702 is implemented as an AP (e.g., AP 104, AP 302), the wireless device 702 may also comprise an EDCA component 724. The EDCA component 724 may be configured to determine whether the wireless device 702 supports adaptive EDCA. The EDCA component 724 may be configured to transmit a message to a station based on the determination. In an aspect, the message may indicate one or more EDCA parameters allowed for adjustment (e.g., one or more EDCA parameters for adjustment 730) and an adjustment range per EDCA parameter (e.g., adjustment ranges for EDCA parameters 732). In another aspect, the message may include an indicator for enabling adaptive EDCA. In another configuration, the EDCA component 724 may be configured to determine a communication parameter used for adjusting at least one EDCA parameter. In this configuration, the EDCA component 724 may be configured to determine an EDCA parameter value (e.g., EDCA parameter value 728) for adjusting the at least one EDCA parameter based on the determined communication parameter. In an aspect, the message may include at least one of the determined communication parameter for adjusting the at least one EDCA parameter or the determined EDCA parameter value for adjusting the at least one EDCA parameter. In another aspect, the message may include an EDCA parameter lookup table. The EDCA parameter lookup table may include one or more EDCA parameters associated with a communication parameter. In another aspect, the communication parameter may be an ED level, an RSSI between the station and the wireless device 702, or a distance between the station and the wireless device 702.

The various components of the wireless device 702 may be coupled together by a bus system 726. The bus system 726 may include a data bus, for example, as well as a power bus, a control signal bus, and a status signal bus in addition to the data bus. Components of the wireless device 702 may be coupled together or accept or provide inputs to each other using some other mechanism.

Although a number of separate components are illustrated in FIG. 7, one or more of the components may be combined or commonly implemented. For example, the processor 704 may be used to implement not only the functionality described above with respect to the processor 704, but also to implement the functionality described above with respect to the signal detector 718, the DSP 720, the user interface 722, and/or the EDCA component 724. Further, each of the components illustrated in FIG. 7 may be implemented using a plurality of separate elements.

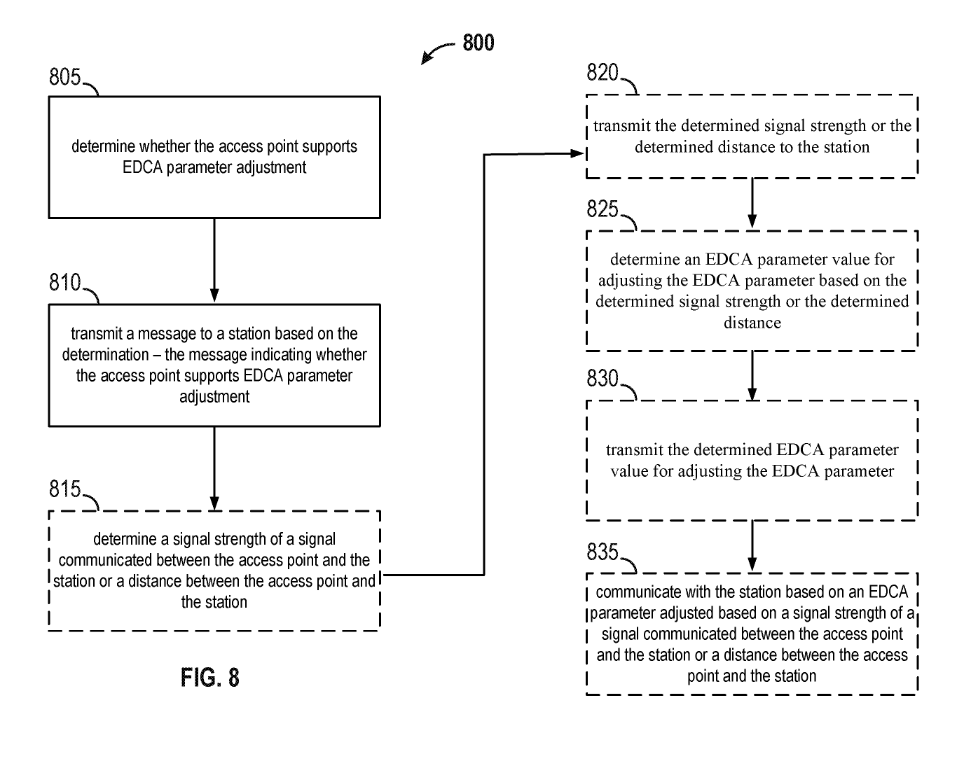

FIG. 8 is a flowchart of an example method 800 of wireless communication for adaptive EDCA. The method 800 may be performed using an apparatus (e.g., the AP 104, the AP 302, or the wireless device 702, for example). Although the method 800 is described below with respect to the elements of wireless device 702 of FIG. 7, other components may be used to implement one or more of the steps described herein.

At block 805, the apparatus may determine whether the apparatus supports EDCA parameter adjustment. For example, referring to FIG. 3, the AP 302 may determine whether the AP 302 supports adaptive EDCA. In an aspect, the AP 302 may be pre-configured to support adaptive EDCA. The AP 302 may determine whether the AP 302 supports adaptive EDCA based on stored configuration information. For example, a bit indicator may indicate whether the AP 302 supports adaptive EDCA (e.g., 0=does not support adaptive EDCA, 1=supports adaptive EDCA).

At block 810, the apparatus may transmit a message to a station based on the determination. The message may indicate whether the access point supports EDCA parameter adjustment. For example, the AP 302 may transmit the first message 312 and/or the second message 314 to the STA 306, indicating to the STA 306 that the AP 302 supports adaptive EDCA.

At block 815, the apparatus may determine a signal strength communicated between the apparatus and the station or a distance between the access point and the station. For example, the AP 302 may determine an ED level used for adjusting the CWMIN and TXOP. In another example, the AP 302 may determine an RSSI used for adjusting the CWMAX and AIFSN. In an aspect, the RSSI may be determined based on a report sent by the STA 306. In another aspect, the AP 302 may determine the RSSI based on uplink packets transmitted by the STA 306. Having determined the RSSI, the AP 302 may determine the ED level using Eq. 2 mentioned above. In yet another example, the AP 302 may determine a distance between the AP 302 and the STA 306 used for adjusting the TXOP.

At block 820, the apparatus may transmit the determined signal strength or the determined distance to the station. For example, referring to FIG. 3, the AP 302 may transmit the ED level, the RSSI, or the distance to the STA 306.

At block 825, the apparatus may determine an EDCA parameter value for adjusting the at least one EDCA parameter based on the determined signal strength or the determined distance. At block 830, the apparatus may transmit the determined EDCA parameter value for adjusting the EDCA parameter. For example, the AP 302 may determine CWMIN and CWMAX values for adjusting the CWMIN and CWMAX parameters (e.g., based on Eqs. 3-6). The AP 302 may transmit the CWMIN and CWMAX values in the second message 314 to the STA 306. In another aspect, the AP 302 may transmit an ED level, an RSSI, or a distance determined at block 815 in the second message 314 to the STA 306. In this aspect, upon receiving an ED level the second message 314, for example, the STA 306 may adjust at least one EDCA parameter based on the second message 314. The STA 306 may adjust the at least one EDCA parameter based on the ED level and the aforementioned equations. The STA 306 may adjust the at least one EDCA parameter based on the ED level and a EDCA parameter lookup table.

At block 830, the apparatus may communicate with the station based on an EDCA parameter adjusted based on a signal strength of a signal communicated between the apparatus and the station or a distance between the apparatus and the station. For example, referring to FIG. 3, the AP 302 may communicate with the STA 306 based on the CWMIN parameter adjusted based on the distance between the AP 302 and the STA 306.

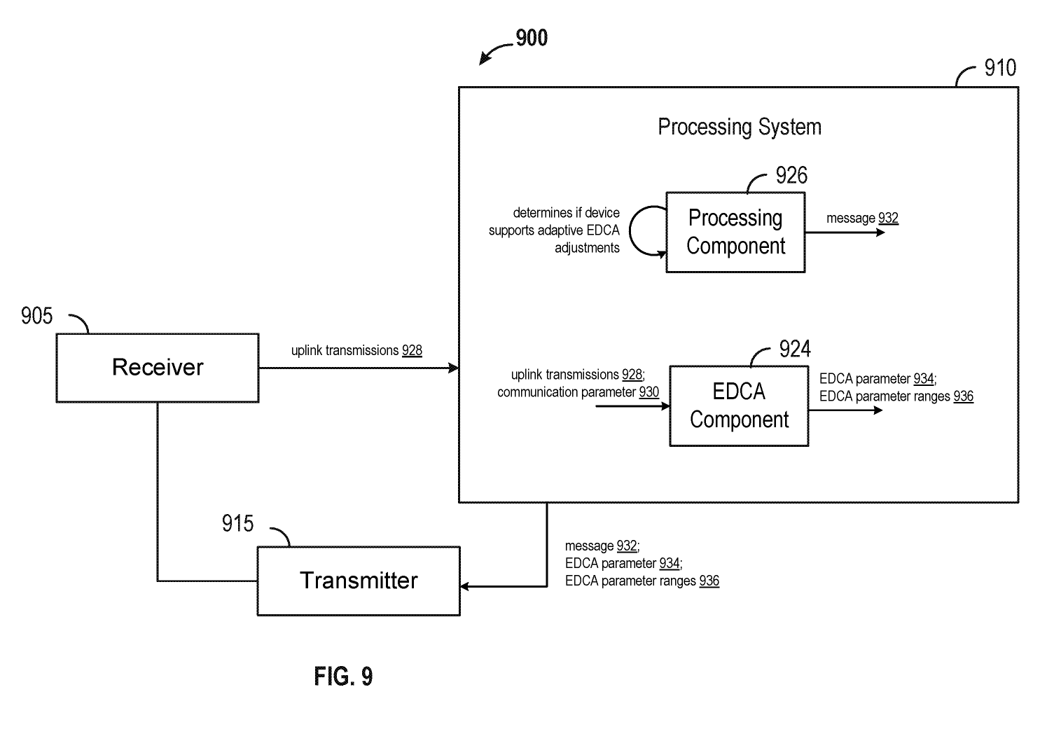

FIG. 9 is a functional block diagram of an example wireless communication device 900. The wireless communication device 900 may include a receiver 905, a processing system 910, and a transmitter 915. The processing system 910 may include an EDCA component 924 and/or a processing component 926. The processing system 910, the processing component 926, and/or the EDCA component 924 may be configured to determine whether the apparatus supports adaptive EDCA. The processing system 910, the EDCA component 924, and/or the transmitter 915 may be configured to transmit a message (e.g., a message 932) to a station based on the determination. In an aspect, the message may indicate one or more EDCA parameters allowed for adjustment (e.g., EDCA parameter 934) and an adjustment range per EDCA parameter (e.g., EDCA parameter ranges 936). In another aspect, the message may include an indicator for enabling adaptive EDCA. The processing system 910 and/or the EDCA component 924 may be configured to determine a communication parameter used for adjusting at least one EDCA parameter. The processing system 910 and/or the EDCA component 924 may be configured to determine an EDCA parameter value for adjusting the at least one EDCA parameter based on the determined communication parameter. The message may include at least one of the determined communication parameter for adjusting the at least one EDCA parameter or the determined EDCA parameter value for adjusting the at least one EDCA parameter. In aspect, the message may include an EDCA parameter lookup table. In this aspect, the EDCA parameter lookup table may include one or more EDCA parameters associated with a communication parameter. In another aspect, the communication parameter (e.g., communication parameter 930) may be an ED level, an RSSI between the apparatus and the access point (e.g., determined base on uplink transmissions 928), or a distance between the station and the apparatus.

The receiver 905, the processing system 910, the EDCA component 924, and/or the transmitter 915 may be configured to perform one or more functions discussed above with respect to blocks 805, 810, 815, and 820 of FIG. 8. The receiver 905 may correspond to the receiver 712. The processing system 910 may correspond to the processor 704. The transmitter 915 may correspond to the transmitter 710. The EDCA component 924 may correspond to the EDCA component 124 and/or the EDCA component 724.

In one configuration, the wireless communication device 900 may include means for determining whether the wireless communication device 900 supports EDCA parameter adjustment and means for transmitting a message to a station based on the determination. The message may indicate whether the wireless communication device 900 supports EDCA parameter adjustment. In another configuration, the wireless communication device 900 may include means for communicating with the station based on an EDCA parameter adjusted based on a signal strength of a signal communicated between the wireless communication device 900 and the station or a distance between the wireless communication device 900 and the station. In another aspect, the EDCA parameter may include one of a CWMIN parameter, a CWMAX parameter, an AIFSN parameter, or a TXOP parameter. In another configuration, the wireless communication device 900 may include means for determining a signal strength of a signal communicated between the apparatus and the station or a distance between the apparatus and the station. In another configuration, the wireless communication device 900 may include means for transmitting the determined signal strength or the determined distance to the station. In another configuration, the wireless communication device 900 may include means for determining an EDCA parameter value for adjusting the EDCA parameter based on the determined signal strength or the determined distance and means for transmitting the determined EDCA parameter value for adjusting the EDCA parameter. In another configuration, the wireless communication device 900 may include means for transmitting an EDCA parameter lookup table. The EDCA parameter lookup table may include one or more EDCA parameters associated with a signal strength of a signal communicated between the wireless communication device 900 and the station or a distance between the wireless communication device 900 and the station.

For example, means for determining whether the wireless communication device 900 supports EDCA parameter adjustment may include the processing system 910, the processing component 926, and/or the EDCA component 924. Means for transmitting a message may include the processing system 910, the EDCA component 924, and/or the transmitter 915. Means for determining a a signal strength or a distance may include the processing system 910 and/or the EDCA component 924. Means for determining an EDCA parameter value may include the processing system 910 and/or the EDCA component 924.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an application specific integrated circuit (ASIC), an FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and blu-ray disc where disks usually reproduce data magnetically, while discs reproduce data optically with lasers. Thus, computer readable medium comprises a non-transitory computer readable medium (e.g., tangible media).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

What is claimed is:

1. A method of wireless communication by a station, comprising:
adjusting an enhanced distributed channel access (EDCA) parameter based on a signal strength of a signal from an access point or a distance between the station and the access point; and
communicating with the access point based on the adjusted EDCA parameter.

2. The method of claim 1, wherein the EDCA parameter comprises one of a contention window minimum (CWMIN) parameter, a contention window maximum (CWMAX) parameter, an arbitration inter-frame space number (AIFSN) parameter, or a transmit opportunity (TXOP) parameter.

3. The method of claim 2, wherein the EDCA parameter comprises one of the CWMIN parameter, the CWMAX parameter, or the AIFSN parameter, and the adjusting the EDCA parameter comprises increasing the EDCA parameter in proportion to the signal strength or the distance.

4. The method of claim 2, wherein the EDCA parameter comprises the TXOP parameter, and the adjusting the EDCA parameter comprises decreasing the EDCA parameter in proportion to the signal strength or the distance.

5. The method of claim 1, wherein the adjusting the EDCA parameter comprises:
determining a normalized parameter based on the signal strength or the distance; and
adjusting the EDCA parameter based on the normalized parameter and a range associated with the EDCA parameter, the range comprising a maximum value and a minimum value.

6. The method of claim 5, wherein the normalized parameter is determined based on the signal strength or the distance, a maximum parameter value associated with the signal strength or the distance, and a minimum parameter value associated with the signal strength or the distance.

7. The method of claim 5, wherein the normalized parameter is a function of an energy detection (ED) level, a received signal strength indication (RSSI) between the access point and the station, or the distance.

8. The method of claim 1, further comprising receiving information from the access point indicating at least one of the EDCA parameter to adjust or an EDCA parameter range for adjusting the EDCA parameter.

9. The method of claim 1, further comprising receiving an indicator enabling adjustment of the EDCA parameter, wherein the EDCA parameter is adjusted after receiving the indicator.

10. The method of claim 1, further comprising receiving an indication that the access point supports EDCA parameter adjustment, wherein the EDCA parameter is adjusted after receiving the indication.

11. The method of claim 1, wherein the adjusting the EDCA parameter is based on the signal strength or the distance and based on an EDCA parameter lookup table, wherein the EDCA parameter lookup table includes one or more EDCA parameters associated with the signal strength or the distance.

12. The method of claim 1, further comprising receiving, from the access point, information used by the station for adjusting the EDCA parameter.

13. A method of wireless communication by an access point, comprising:
determining whether the access point supports enhanced distributed channel access (EDCA) parameter adjustment; and
transmitting a message to a station based on the determination, the message indicating whether the access point supports EDCA parameter adjustment.

14. The method of claim 13, further comprising communicating with the station based on an EDCA parameter adjusted based on a signal strength of a signal communicated between the access point and the station or a distance between the access point and the station.

15. The method of claim 14, wherein the EDCA parameter comprises one of a contention window minimum (CWMIN) parameter, a contention window maximum (CWMAX) parameter, an arbitration inter-frame space number (AIFSN) parameter, or a transmit opportunity (TXOP) parameter.

16. The method of claim 13, further comprising determining a signal strength of a signal communicated between the access point and the station or a distance between the access point and the station.

17. The method of claim 16, further comprising transmitting the determined signal strength or the determined distance to the station.

18. The method of claim 16, further comprising:
determining an EDCA parameter value for adjusting the EDCA parameter based on the determined signal strength or the determined distance; and
transmitting the determined EDCA parameter value for adjusting the EDCA parameter.

19. The method of claim 13, further comprising transmitting an EDCA parameter lookup table, the EDCA parameter lookup table including one or more EDCA parameters associated with a signal strength of a signal communicated between the access point and the station or a distance between the access point and the station.

20. An apparatus for wireless communication, the apparatus being a station, comprising:
a memory; and
at least one processor coupled to the memory and configured to:
adjust an enhanced distributed channel access (EDCA) parameter based on a signal strength of a signal from an access point or a distance between the station and the access point; and
communicate with the access point based on the adjusted EDCA parameter.

21. The apparatus of claim 20, wherein the EDCA parameter comprises one of a contention window minimum (CWMIN) parameter, a contention window maximum (CWMAX) parameter, an arbitration inter-frame space number (AIFSN) parameter, or a transmit opportunity (TXOP) parameter.

22. The apparatus of claim 20, wherein the at least one processor is configured to adjust the EDCA parameter by:
determining a normalized parameter based on the signal strength or the distance; and
adjusting the EDCA parameter based on the normalized parameter and a range associated with the EDCA parameter, the range comprising a maximum value and a minimum value.

23. The apparatus of claim 20, wherein the at least one processor is further configured to receive information from the access point indicating at least one of the EDCA parameter to adjust or an EDCA parameter range for adjusting the EDCA parameter.

24. The apparatus of claim 20, wherein the at least one processor is further configured to receive an indicator enabling adjustment of the EDCA parameter, wherein the EDCA parameter is adjusted after receiving the indicator.

25. The apparatus of claim 20, wherein the at least one processor is further configured to receive an indication that the access point supports EDCA parameter adjustment, wherein the EDCA parameter is adjusted after receiving the indication.

26. The apparatus of claim 20, wherein the at least one processor is further configured to receive, from the access point, information used by the station for adjusting the EDCA parameter.

27. An apparatus for wireless communication, the apparatus being an access point, comprising:
a memory; and
at least one processor coupled to the memory and configured to:
determine whether the access point supports enhanced distributed channel access (EDCA) parameter adjustment; and
transmit a message to a station based on the determination, the message indicating whether the access point supports EDCA parameter adjustment.

28. The apparatus of claim 27, wherein the at least one processor is further configured to determine a signal strength of a signal communicated between the access point and the station or a distance between the access point and the station.

29. The apparatus of claim 28, wherein the at least one processor is further configured to transmit the determined signal strength or the determined distance to the station.

30. The apparatus of claim 28, wherein the at least one processor is further configured to:
determine an EDCA parameter value for adjusting the EDCA parameter based on the determined signal strength or the determined distance; and
transmit the determined EDCA parameter value for adjusting the EDCA parameter.
